(19) United States
(12) Patent Application Publication
(10) Pub. No.: US 2026/0229755 A1
(43) Pub. Date: Aug. 6, 2026

(54) DIFFERENTIAL POWER DIVIDER/COMBINER WITH OPPOSING SPIRAL CONFIGURATIONS

(71) Applicant: NXP B.V., Eindhoven (NL)

(72) Inventors: Mark Pieter van der Heijden, Eindhoven (NL); Leo Lucas Lancon, Pessac (FR); Xin Yang, Eindhoven (NL); Sebastien Pruvost, Crolles (FR)

(21) Appl. No.: 19/363,171

(22) Filed: Oct. 20, 2025

(30) Foreign Application Priority Data
Oct. 23, 2024 (EP) 24306783.2

(51) Int. Cl. H01P 1/16

(52) U.S. Cl. CPC H01P 1/16

(57) ABSTRACT

Symmetric spiral configurations of portions of a negative trace and a positive trace with opposite orientations provide for a field cancellation effect in a Wilkinson power divider (or combiner), wherein magnetic fields produced by the positive trace are substantially cancelled out by magnetic fields produced by the negative trace. The geometries of the positive trace and the negative trace effectively produce isolation inductors. Some implementations utilize a transformer, which includes a first positive input port and a first negative input port, an amplifier, and a transformer, which include an input shunt inductor of the differential power divider as part of the transformer.

### CROSS-REFERENCE TO RELATED APPLICATIONS

This application claims priority under 35 U.S.C. § 119 to European patent application no.24306783.2, filed Oct. 23, 2024, the contents of which are incorporated by reference herein.

### BACKGROUND

The present disclosure relates generally to a Wilkinson divider, which can function as a power splitter or power combiner in, but not limited to, a radio frequency (RF) implementation. In the field of RF and microwave engineering, the Wilkinson power divider is a specific class of power divider circuit that can achieve isolation between output ports while maintaining a matched condition on all ports such that the impedance of the source and the load are substantially equal to maximize power transfer and minimize reflections at a desired operating frequency range. A conventional Wilkinson power divider splits an input signal into two equal phase output signals or combines two equal-phase signals into one signal. Thus, Wilkinson power dividers are typically reversible and often referred to as either a Wilkinson power splitter or combiner depending on how they are utilized in a circuit.

Conventional Wilkinson power dividers are easily implemented using printed components on a printed circuit board utilizing quarter wave (λ/4) transmission lines (TLs) to implement the required power combination or power split at a specific frequency. Typical designs use quarter wavelength transformers to split an input signal and to provide two output signals that are in phase. At lower frequencies, this implementation can be bulky in size due to required dimensions of the λ/4 TLs. Accordingly, such an implementation of the Wilkinson power divider tends to be used more often at higher, e.g., microwave, frequencies where the λ/4 transmission line lengths are not prohibitively large. Other designs use “lumped” element configurations that utilize, e.g., discrete circuit elements. “Lumped” element designs use discrete components such as resistors, capacitors, and inductors, which are treated as individual, concentrated circuit elements. In contrast with distributed elements based on TL theory that spread a circuit's reactive components over a length of TL, lumped elements are considered to have all their properties (resistance, capacitance, or inductance) concentrated at a single point or in discrete components. However, the use of lumped element components also makes accurate amplitude and phase matching of output ports more difficult due to different component tolerances.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a circuit diagram of a two-way differential power divider in accordance with some embodiments.

FIG. 2 is a perspective view showing a first layer of a two-way differential power divider in accordance with some embodiments.

FIG. 3 is a perspective view showing a second layer of a two-way differential power divider in accordance with some embodiments.

FIG. 4 is a perspective view showing a third layer of a two-way differential power divider in accordance with some embodiments.

FIG. 5 is a perspective view showing a fourth layer of a two-way differential power divider in accordance with some embodiments.

FIG. 6 is a circuit diagram of a three-way differential power divider using a star-connected isolation network in accordance with some embodiments.

FIG. 7 is a circuit diagram of a three-way differential power divider using a delta-connected isolation network in accordance with some embodiments.

FIG. 8 is a circuit diagram of a transformer usable with a differential power divider in accordance with some embodiments.

FIG. 9 is a perspective view of an isolation network of a first layer of a three- or four-way differential power divider in accordance with some embodiments.

FIG. 10 is a perspective view showing a second layer of an isolation network of a three- or four-way differential power divider in accordance with some embodiments.

FIG. 11 is a top view of a three-way differential power divider including a transformer in accordance with some embodiments.

FIG. 12 is a flow diagram of a method of assembling a differential power divider in accordance with some embodiments.

FIG. 13 is a flow diagram of a method of arranging traces in a differential power divider in accordance with some embodiments.

### SUMMARY OF EMBODIMENTS

In a first example embodiment, a differential Wilkinson power divider includes an input shunt inductor between a positive input terminal and a negative input terminal; a first isolation inductor between a first positive output terminal and a second positive output terminal; and a second isolation inductor between a first negative output terminal and a second negative output terminal, where the first isolation inductor and the second isolation inductor have a first mutual inductance, the input shunt inductor and the first isolation inductor have a second mutual inductance, and a coefficient of coupling of the first mutual inductance has a higher magnitude than a coefficient of coupling of the second mutual inductance. In some embodiments, the input shunt inductor and the second isolation inductor have a third mutual inductance, and a coefficient of coupling of the first mutual inductance has a higher magnitude than a coefficient of coupling of the third mutual inductance. In some embodiments, the power divider further includes a third positive output terminal and a third negative output terminal corresponding to the third positive output terminal; and a first delta- or star-connected isolation network connected between the first positive output terminal, the second positive output terminal, and the third positive output terminal, where the first isolation network comprises the first isolation inductor. In some embodiments, the power divider further includes a second delta- or star-connected isolation network connected between the first negative output terminal, the second negative output terminal, and the third negative output terminal, where the second isolation network comprises the second isolation inductor.

In a second example embodiment, a differential Wilkinson power divider includes a negative trace comprising a first negative portion and a second negative portion; and a positive trace comprising a first positive portion and a second positive portion, where the first negative portion of the negative trace includes a first spiral configuration, the second negative portion of the negative trace includes a second spiral configuration, and the first spiral configuration and the second spiral configuration have a first chirality, and where the first positive portion of the positive trace includes a third spiral configuration, the second positive portion of the positive trace includes a fourth spiral configuration, the third spiral configuration and the fourth spiral configuration have a second chirality, and the second chirality is different from the first chirality. In some embodiments, the first chirality is opposite to the second chirality. In some embodiments, the first chirality is clockwise and the second chirality is counter-clockwise. In some embodiments, the first chirality is counter-clockwise and the second chirality is clockwise. In some embodiments, a shape of the first spiral configuration is identical to a shape of the second spiral configuration when the shape of the second spiral configuration is rotated 180 degrees. In some embodiments, a shape of the third spiral configuration is identical to a shape of the fourth spiral configuration when the shape of the fourth spiral configuration is rotated 180 degrees. In some embodiments, the negative trace further comprises a third negative portion and a fourth negative portion; the positive trace further comprises a third positive portion and a fourth positive portion; the third negative portion of the negative trace includes a fifth spiral configuration, the fourth negative portion of the negative trace includes a sixth spiral configuration, and the fifth spiral configuration and the sixth spiral configuration have the first chirality; and the third positive portion of the positive trace includes a seventh spiral configuration, the fourth positive portion of the positive trace includes an eighth spiral configuration, and the seventh spiral configuration and the eighth spiral configuration have the second chirality. In some embodiments, a shape of the first spiral configuration is identical to a shape of the second spiral configuration when the shape of the second spiral configuration is rotated 90 degrees. In some embodiments, the shape of the second spiral configuration is identical to a shape of the fifth spiral configuration when the shape of the fifth spiral configuration is rotated 90 degrees. In some embodiments, a shape of the third spiral configuration is identical to a shape of the fourth spiral configuration when the shape of the fourth spiral configuration is rotated 90 degrees. In some embodiments, the shape of the fourth spiral configuration is identical to a shape of the seventh spiral configuration when the shape of the seventh spiral configuration is rotated 90 degrees. In some embodiments, the positive trace forms a first isolation inductor between a first positive output terminal and a second positive output terminal; and the negative trace forms a second isolation inductor between a first negative output terminal and a second negative output terminal, where the first isolation inductor and the second isolation inductor have a first mutual inductance, the input shunt inductor and the first isolation inductor have a second mutual inductance, and a coefficient of coupling of the first mutual inductance has a higher magnitude than a coefficient of coupling of the second mutual inductance. In some embodiments, the differential Wilkinson power divider includes an input shunt inductor between a positive input terminal and a negative input terminal.

In a third example embodiment, a method of assembling a Wilkinson power divider includes connecting an input shunt inductor between a positive input terminal and a negative input terminal; connecting a first isolation inductor between a first positive output terminal and a second positive output terminal; and connecting a second isolation inductor between a first negative output terminal and a second negative output terminal, where the first isolation inductor and the second isolation inductor have a first mutual inductance, the input shunt inductor and the first isolation inductor have a second mutual inductance, and a coefficient of coupling of the first mutual inductance has a higher magnitude than a coefficient of coupling of the second mutual inductance. In some embodiments, the input shunt inductor and the second isolation inductor have a third mutual inductance, and a coefficient of coupling of the first mutual inductance has a higher magnitude than a coefficient of coupling of the third mutual inductance. In some embodiments, the method further includes connecting a first delta- or star-connected isolation network between the first positive output terminal, the second positive output terminal, and a third positive output terminal, where the first isolation network comprises the first isolation inductor. In some embodiments, the method further includes connecting a second delta- or star-connected isolation network between the first negative output terminal, the second negative output terminal, and a third negative output terminal, where the second isolation network comprises the second isolation inductor. In some embodiments, the method further includes connecting a third isolation inductor between the first positive output terminal and the third positive output terminal.

In a fourth example embodiment, a differential Wilkinson power divider includes a negative trace comprising a first negative portion and a second negative portion and forming a first isolation inductor between a first positive output terminal and a second positive output terminal; and a positive trace comprising a first positive portion and a second positive portion and forming a second isolation inductor between a first negative output terminal and a second negative output terminal, wherein the first negative portion of the negative trace includes a first spiral configuration, the second negative portion of the negative trace includes a second spiral configuration, and the first spiral configuration and the second spiral configuration have a first orientation, wherein the first positive portion of the positive trace includes a third spiral configuration, the second positive portion of the positive trace includes a fourth spiral configuration, the third spiral configuration and the fourth spiral configuration have a second orientation, and the second orientation is different from the first orientation, and wherein the first isolation inductor and the second isolation inductor have a first mutual inductance, the input shunt inductor and the first isolation inductor have a second mutual inductance, and a coefficient of coupling of the first mutual inductance has a higher magnitude than a coefficient of coupling of the second mutual inductance. In some embodiments, the Wilkinson power divider includes an input shunt inductor between a positive input terminal and a negative input terminal. In some embodiments, the first orientation is opposite to the second orientation.

### DETAILED DESCRIPTION

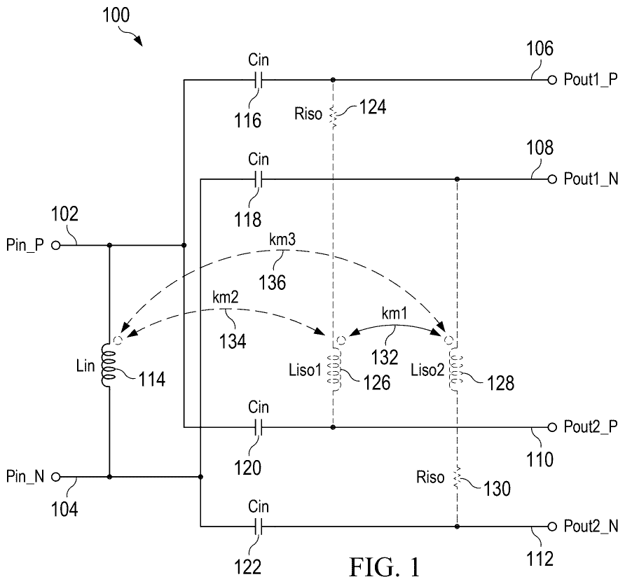

FIGS. 1-13 illustrate systems and techniques for implementing 2-way, 3-way, or N-way (e.g., 4-or-more-way) Wilkinson power dividers with balanced outputs, high performance characteristics, and compact form factors. In some embodiments, symmetric spiral configurations are used for portions of a negative trace and a positive trace of an isolation network in a power divider with opposite chirality (e.g., clockwise or counter-clockwise orientations). As described further hereinbelow, these variously symmetric spiral configurations provide for a field cancellation effect, such that magnetic fields produced by the positive trace are substantially offset or cancelled out by magnetic fields produced by the negative trace. The geometries of the positive trace and the negative trace effectively produce isolation inductors for the isolation network while the trace resistances of the positive and negative traces provide for isolation resistors of the isolation network, saving space and reducing costs that may otherwise be required if discrete inductor and resistor components were used. Some implementations utilize a transformer, which includes an input shunt inductor of the differential power divider as part of the transformer, saving space and ensuring a compact circuit layout with a minimal on-chip footprint.

FIG. 1 is a circuit diagram of a two-way differential power divider 100 in accordance with some embodiments, which functions substantially as a Wilkinson power divider, as, in some embodiments, it provides isolation between the output ports while maintaining a matched condition on all ports. As shown in FIG. 1, the two-way differential power divider 100 includes a positive input terminal 102 and a negative input terminal 104, sometimes referred to as positive and negative input ports. Differential circuits are typically designed to reject common-mode noise that affects both input traces similarly, while differential Wilkinson splitters are designed to duplicate two input signals, such as the positive input terminal 102 and the negative input terminal 104 of the two-way differential power divider 100 of FIG. 1, with minimal loss and high isolation between the outputs.

To provide the input signals as duplicated sets of output signals, the two-way differential power divider 100 further includes a first positive output terminal 106 and a first negative output terminal 108 corresponding to the first positive output terminal 106, as well as a second positive output terminal 110 and a second negative output terminal 112 corresponding to the second positive output terminal 110, sometimes referred to as sets of positive and negative output ports. Notably, although the input and output terminals, e.g., the first positive input terminal 102 and the first positive output terminal 106, of the two-way differential power divider 100 are described as input and output terminals, respectively, as discussed above, Wilkinson power dividers are typically reversible and often referred to as either a Wilkinson power splitter or combiner depending on how they are utilized in a circuit. Accordingly, in some embodiments where the two-way differential power divider 100 is used as a power combiner rather than as a power splitter, the terminals of the two-way differential power divider 100 referred to as “input” terminals, such as the first positive input terminal 102, are instead used and function as outputs, while the terminals referred to as “output” terminals, such as the first positive output terminal 106, are instead used and function as inputs. Notably, in some embodiments, only the positive portion or the negative portion of the power divider 100 is used to provide a single-ended topology.

The two-way differential power divider 100 further includes an input shunt inductor 114 between the positive input terminal 102 and the negative input terminal 104 to provide input electrostatic discharge protection, and, in some embodiments, to function as part of a frequency pass, e.g., high-pass, circuit in conjunction with input capacitors associated with each of the output terminals. For example, in some embodiments, a first input capacitor 116 is associated with the first positive output terminal 106, a second input capacitor 118 is associated with the first negative output terminal 108, a third input capacitor 120 is associated with the second positive output terminal 110, and a fourth input capacitor 122 is associated with the second negative output terminal 112.

In some embodiments, in order to provide isolation between the outputs, a first isolation network is connected between the first positive output terminal 106 and the second positive output terminal 110, and a second isolation network is connected between the first negative output terminal 108 and the second negative output terminal 112. As shown in FIG. 1, in some embodiments, the isolation networks include a resistor and an inductor. For example, the isolation network connected between the first positive output terminal 106 and the second positive output terminal 110 includes a first isolation resistor 124 in series with a first isolation inductor 126. Similarly, the isolation network connected between the first negative output terminal 108 and the second negative output terminal 112 includes a second isolation resistor 130 in series with a second isolation inductor 128.

In some embodiments, in order to minimize coupling between the output terminals, the first isolation inductor 126 and the second isolation inductor 128 have a first mutual inductance 132, the input shunt inductor 114 and the first isolation inductor 126 have a second mutual inductance 134, and a coefficient of coupling of the first mutual inductance 132 has a higher magnitude than a coefficient of coupling of the second mutual inductance 134. For example, in some embodiments, the second mutual inductance 134 between the input shunt inductor 114 and the first isolation inductor 126 is approximately or substantially zero, while the first mutual inductance 132 between the first isolation inductor 126 and the second isolation inductor 128 is approximately or substantially nonzero, e.g., a negative coupling between zero and −1.

To ensure that mutual coupling between the second isolation inductor 128 and the input shunt inductor 114 is also minimized, in some embodiments, the input shunt inductor 114 and the second isolation inductor 128 have a third mutual inductance 136, and a coefficient of coupling of the first mutual inductance 132 has a higher magnitude than a coefficient of coupling of the third mutual inductance 136. For example, in some embodiments, the third mutual inductance 136 between the input shunt inductor 114 and the second isolation inductor 128 is approximately or substantially zero, while, as noted above, the first mutual inductance 132 between the first isolation inductor 126 and the second isolation inductor 128 is approximately or substantially nonzero, e.g., a negative coupling between zero and −1.

Although the specific, actual values for the resistors, capacitors, and inductors of the two-way differential power divider 100 will vary, and thus will need to be selected in accordance with specific implementations and tolerances, in some embodiments, these components are selected in accordance with the following equations 1-4, where Z0 is the characteristic impedance of the circuit and ω is the targeted angular frequency. As shown in FIG. 1, Lin represents a value for the input shunt inductor 114, Cin represents a value for the input capacitors 116, 118, 120, 122, Liso represents a value for the isolation inductors 126, 128, and Riso represents a value for the isolation resistors 124, 130.

$$Lin = Z 0 / ω \qquad [ 1 ]$$

$$Cin = 2 / ( Z 0 * ω ) \qquad [ 2 ]$$

$$Liso = Z 0 / 2 / ω / ( 1 - km 1 ) \qquad [ 3 ]$$

$$Riso = Z 0 / 2 \qquad [ 4 ]$$

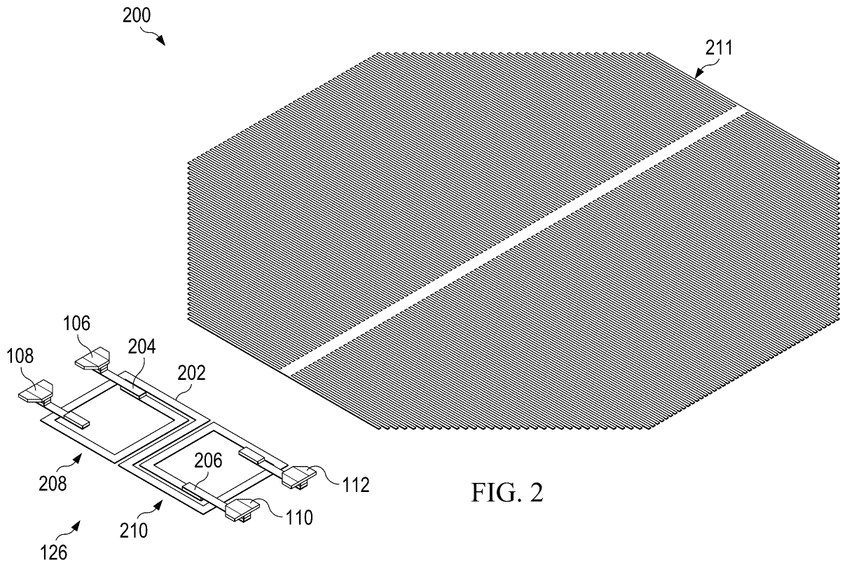

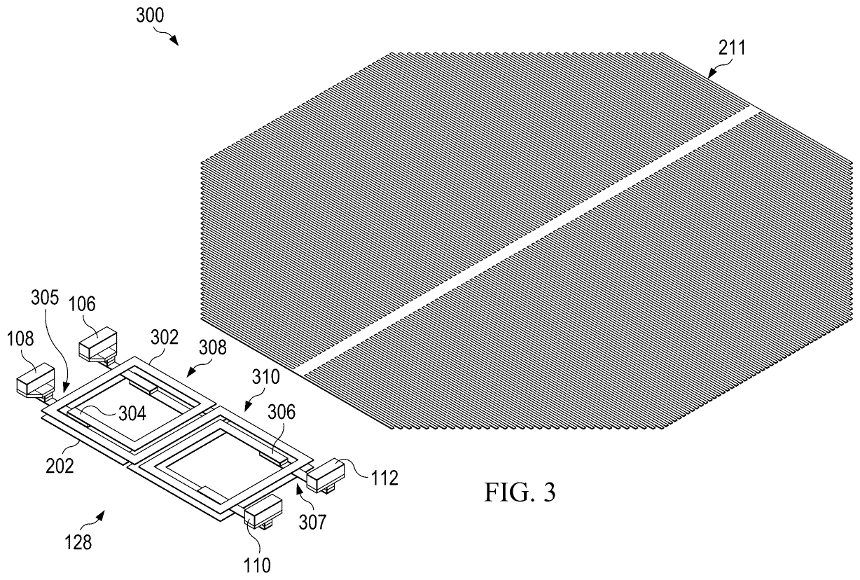

FIG. 2 is a perspective view showing first layers 200 of a two-way differential power divider such as the two-way differential power divider 100 of FIG. 1 in accordance with some embodiments. As shown in FIG. 2, in some embodiments, the first positive output terminal 106 and the second positive output terminal 110 of a two-way differential power divider are connected to a positive trace 202 at contact points 204 and 206, respectively. The positive trace 202 includes a first positive portion 208 and a second positive portion 210. As shown in FIG. 2, the two-way differential power divider also includes the first negative output terminal 108 and the second negative output terminal 112, as well as an electromagnetic shield 211, which are described in further detail hereinbelow with reference to FIGS. 3-5.

FIG. 3 is a perspective view showing a second layer 300 of a two-way differential power divider such as the two-way differential power divider 100 of FIG. 1 in accordance with some embodiments. The first negative output terminal 108 and the second negative output terminal 112 are connected to a negative trace 302 of the two-way differential power divider at contact points 304 and 306, respectively, using traces that pass between the positive trace 202 and the negative trace 302 at non-contact locations 305 and 307, respectively. As shown in FIG. 3, the negative trace 302 includes a first negative portion 308 and a second negative portion 310. As will be appreciated from FIGS. 2 and 3, the positive trace 202 has rotational symmetry with the negative trace 302, as rotating the positive trace 202 by 180 degrees around an axis along the center of its width or its length produces the same shape as the negative trace 302. As will also be appreciated from FIG. 3, the first negative portion 308 of the negative trace 302 includes a first spiral configuration, the second negative portion 310 of the negative trace 302 includes a second spiral configuration, and the first spiral configuration and the second spiral configuration have a first chirality, sometimes also referred to as a “handedness.” In this case, as can be seen in FIG. 3, the first chirality of the first spiral configuration of the first negative portion 308 and the second spiral configuration of the second negative portion 310 of the negative trace 302 is clockwise (i.e., winds inward in a clockwise direction) when viewed from the perspective of FIG. 3.

Generally, chirality is defined as a property of an object that makes the object non-superimposable on its mirror image. For example, two spirals or coils that are mirror images of each other but cannot be superimposed have opposite chirality, also referred to as opposite orientations. As used herein, the term “clockwise” refers to an orientation of a spiral or coil configuration where an outer portion of the spiral or coil winds inward in a clockwise direction when viewed from a particular perspective; thus, the inner portion of a “clockwise” spiral or coil winds outward in a counter-clockwise direction when viewed from the same particular perspective. On the other hand, the term “counter-clockwise” refers to an orientation of a spiral or coil configuration where an outer portion of the spiral or coil winds inward in a counter-clockwise direction when viewed from a particular perspective; thus, the inner portion of a “counter-clockwise” spiral or coil winds outward in a clockwise direction when viewed from the same particular perspective. Generally, as used herein, differences in chirality, orientation, and handedness and clockwise and counter-clockwise properties refer to the physical appearance of components when those components are viewed from a particular perspective.

In contrast with the first chirality of the spiral configurations of the negative trace 302, referring back to FIG. 2, the first positive portion 208 of the positive trace 202 includes a third spiral configuration, the second positive portion 210 of the positive trace 202 includes a fourth spiral configuration, and the third spiral configuration and the fourth spiral configuration have a second chirality that is different from the first chirality of the negative trace 302 shown in FIG. 3. In particular, as shown in FIG. 2, the second chirality of the third spiral configuration of the first positive portion 208 and the fourth spiral configuration of the second positive portion 210 of the positive trace 202 is counter-clockwise (i.e., winds inward in a counter-clockwise direction) when viewed from the perspective of FIG. 3. Thus, the first chirality of the first and second spiral configurations of the first and second negative portions 308, 310 of the negative trace 302 is opposite to the second chirality of the third and fourth spiral configurations of the first and second positive portions 208, 210 of the positive trace 202. However, it will be appreciated that, in some embodiments, the positive trace 202 of the two-way differential power divider can be used as a negative trace and that the negative trace 302 can be used as a positive trace. Accordingly, in some embodiments, the first chirality of the spiral configurations of the negative trace is counter-clockwise while the second chirality of the spiral configurations of the positive trace is clockwise.

As will be appreciated from FIG. 3, rotating the first spiral configuration of the first negative portion 308 of the negative trace 302 by 180 degrees around an axis normal to the plane of the negative trace 302 produces a shape identical to the shape of the second spiral configuration of the second negative portion 310 of the negative trace 302. Similarly, as can be appreciated from FIG. 2, rotating the third spiral configuration of the first positive portion 208 of the positive trace 202 by 180 degrees around an axis normal to the plane of the positive trace 202 produces a shape identical to the shape of the fourth spiral configuration of the second positive portion 210 of the positive trace 202. Using these variously symmetric spiral configurations for the first negative portion 308 and the second negative portion 310 of the negative trace 302 and the first positive portion 208 and the second positive portion 210 of the positive trace 202 where the negative trace 302 and the positive trace 202 include spiral configurations with opposite chirality provides for a field cancellation effect with respect to other components, such as the first inductor coil trace 440 and second inductor coil trace 442. Additionally, as shown in FIGS. 2 and 3, the geometries of the positive trace 202 and the negative trace 302 effectively produce the first isolation inductor 126 and second isolation inductor 128, respectively, of the two-way differential power divider.

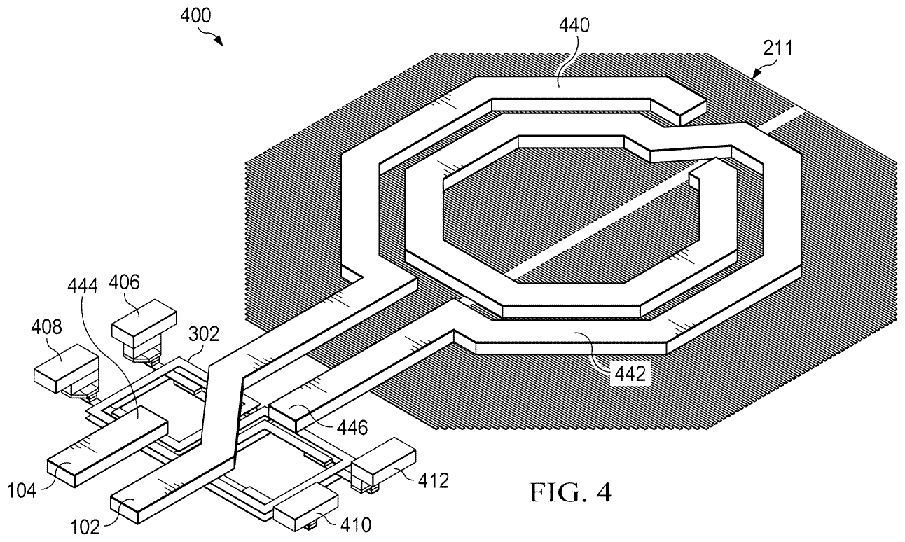

FIG. 4 is a perspective view showing a third layer 400 of a two-way differential power divider such as the two-way differential power divider 100 of FIG. 1 in accordance with some embodiments. Although only the negative trace 302 of FIG. 3 is indicated for clarity, it will be appreciated that each of the components of FIGS. 2 and 3 are also present in the layout of FIG. 4. For example, the first positive output terminal 106 and the first negative output terminal 108 are connected to interconnect traces 406 and 408, respectively, while the second positive output terminal 110 and the second negative output terminal 112 are connected to interconnect traces 410 and 412, respectively. In order to provide input and output terminals, interconnect traces are provided for the positive input terminal 102 and the negative input terminal 104.

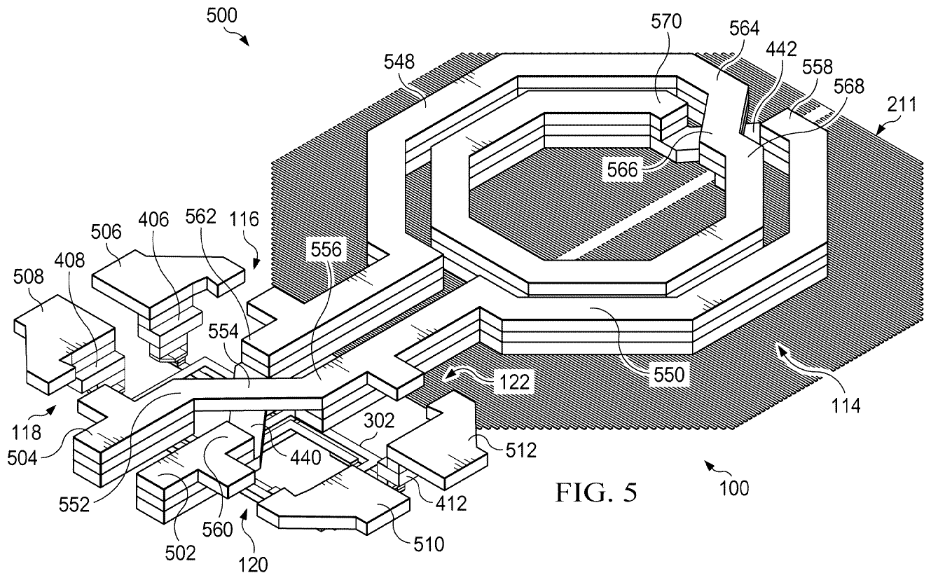

To form the input shunt inductor 114 of the two-way differential power divider, the interconnect trace of the positive input terminal 102 is connected to a first inductor coil trace 440 forming a first portion of the input shunt inductor 114, while a second inductor coil trace 442 forms a second portion of the input shunt inductor 114. As shown in FIG. 4, the first inductor coil trace 440 and the second inductor coil trace 442 of the input shunt inductor are collocated with each other and deposited over the electromagnetic shield 211. Notably, although contact points 444, 446 are shown in FIG. 4, and portions of the interconnect trace associated with the negative input terminal 104, the first inductor coil trace 440, and the second inductor coil trace 442 cross over portions of, e.g., the negative trace 302 of FIG. 3, as explained further hereinbelow with reference to FIG. 5, no portion of the interconnect trace associated with the negative input terminal 104, the first inductor coil trace 440, or the second inductor coil trace 442 are in direct contact with the negative trace 302 shown in detail in FIG. 3 or the positive trace 202 shown in detail in FIG. 2.

FIG. 5 is a perspective view showing a fourth layer 500 of a two-way differential power divider such as the two-way differential power divider 100 of FIG. 1 in accordance with some embodiments. Like in FIG. 4, although only the negative trace 302 of FIG. 3 is indicated for clarity, it will be appreciated that each of the components of FIGS. 2, 3, and 4 are also present in the layout of FIG. 5. For example, the first positive output terminal 106 and the first negative output terminal 108 are connected via the interconnect traces 406 and 408 to top traces 506 and 508, respectively, while the second positive output terminal 110 and the second negative output terminal 112 are connected via the interconnect traces 410 and 412 to top traces 510 and 512, respectively. Similarly, interconnect traces associated with the positive input terminal 102 and the negative input terminal 104, as shown in FIG. 4, are connected to top traces 502 and 504, respectively.

In order to complete the formation of the input shunt inductor 114 of the two-way differential power divider, the top trace 502 of the positive input terminal 102 is connected to a third inductor coil trace 548 forming a third portion of the input shunt inductor 114, while a fourth inductor coil trace 550 forms a fourth portion of the input shunt inductor 114. As shown in FIG. 5, the third inductor coil trace 548 and the fourth inductor coil trace 550 of the input shunt inductor 114 are collocated with each other and deposited over the electromagnetic shield 211. Additionally, portions of the third inductor coil trace 548 and the fourth inductor coil trace 550 are connected with portions of the first inductor coil trace 440, the second inductor coil trace 442, and the interconnect trace associated with the negative input terminal 104, as shown in detail in FIG. 4. For example, the fourth inductor coil trace 550 connects to the interconnect trace associated with the negative input terminal 104 along its length from the top trace 504 of the negative input terminal to contact point 552, crosses the first inductor coil trace 440 at non-contact point 554, and connects to the second inductor coil trace 442 from contact point 556 to contact point 558. Similarly, the top trace 502 associated with the positive input terminal 102 connects to the first inductor coil trace 440 up to contact point 560, while the third inductor coil trace 548 connects to the first inductor coil trace 440 from contact point 562 to contact point 564. The third inductor coil trace 548 then crosses over the second inductor coil trace 442 at non-contact point 566 and connects to the second inductor coil trace 442 from contact point 568 to contact point 570. In this configuration, the traces associated with the input shunt inductor 114 cross at two points, i.e., non-contact point 554 and non-contact point 566, as shown in FIG. 5, and serve to form the input shunt inductor 114.

To complete the two-way differential power divider, the first input capacitor 116 is connected between the top trace 506 associated with the first positive output terminal 106 and the third inductor coil trace 548 proximal to the contact point 562, and the second input capacitor 118 is connected between the top trace 508 associated with the first negative output terminal 108 and the fourth inductor coil trace 550 proximal to the contact point 552. Similarly, the third input capacitor 120 is connected between the top trace 510 associated with the second positive output terminal 110 and the top trace 502 associated with the positive input terminal 102 proximal to the contact point 560, and the fourth input capacitor 122 is connected between the top trace 512 associated with the second negative output terminal 112 and the fourth inductor coil trace 550 proximal to the contact point 556. By arranging the various traces and capacitors in accordance with the layouts of FIGS. 2-5, the two-way differential power divider 100 is fully realized. Notably, the first isolation resistor 124 and the second isolation resistor 130 of the two-way differential power divider 100 are implemented using the trace resistance of the positive trace 202 and the negative trace 302, respectively.

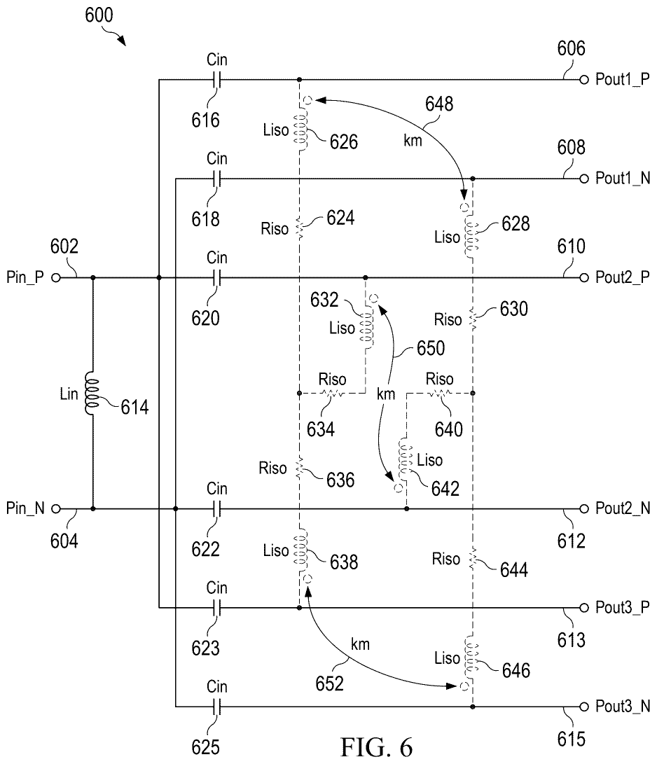

FIG. 6 is a circuit diagram of a three-way differential power divider 600 using a star-connected isolation network in accordance with some embodiments. As will be appreciated from a comparison between FIG. 1 and FIG. 6, the three-way differential power divider 600 includes many similar components to those of the two-way differential power divider 100 of FIG. 1. For example, the three-way differential power divider 600 of FIG. 6 includes a positive input terminal 602 and a negative input terminal 604, a first positive output terminal 606 and a first negative output terminal 608, a second positive output terminal 610 and a second negative output terminal 612, and, differing from the two-way differential power divider 100 of FIG. 1, additionally includes a third positive output terminal 613 and a third negative output terminal 615.

Like the two-way differential power divider 100 of FIG. 1, each of the output terminals of the three-way differential power divider 600 is associated with an input capacitor, i.e., input capacitors 616, 618, 620, 622, 623, and 625, and an isolation network is provided to isolate the output terminals from one another. In the example of the three-way differential power divider 600 of FIG. 6, as noted above, a star-connected isolation network is provided between the respective positive and negative output terminals comprising a number of isolation inductors and isolation resistors, i.e., isolation inductors 626, 628, 632, 638, 642, and 646 and isolation resistors 624, 630, 634, 636, 640, and 644. Additionally, each pair of isolation inductors have an associated mutual inductance, e.g., mutual inductances 648, 650, and 652. Although the specific, actual values for the resistors, capacitors, and inductors of the three-way differential power divider 600 will vary, and thus will need to be selected in accordance with specific implementations and tolerances, in some embodiments, these components are selected in accordance with the following equations 5-8.

$$Lin = Z 0 / √ 2 / ω \qquad [ 5 ]$$

$$Cin = √ 2 / ( Z 0 * ω ) \qquad [ 6 ]$$

$$Liso = Z 0 / 3 / √ 2 / ω * ( 1 - km ) \qquad [ 7 ]$$

$$Riso = Z 0 / 3 \qquad [ 8 ]$$

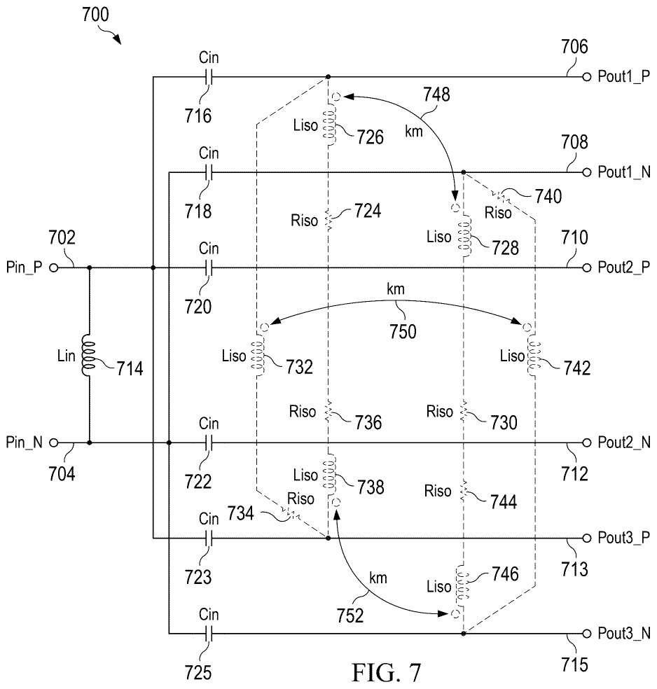

FIG. 7 is a circuit diagram of a three-way differential power divider 700 using a delta-connected isolation network in accordance with some embodiments. As will be appreciated from a comparison of FIG. 1, FIG. 6, and FIG. 7, the three-way differential power divider 700 includes many similar components to those of the two-way differential power divider 100 of FIG. 1 and the three-way differential power divider 600 of FIG. 6. For example, the three-way differential power divider 700 of FIG. 7 includes a positive input terminal 702 and a negative input terminal 704, a first positive output terminal 706 and a first negative output terminal 708, a second positive output terminal 710 and a second negative output terminal 712, and, differing from the two-way differential power divider 100 of FIG. 1 but similar to the three-way differential power divider 600 of FIG. 6, additionally includes a third positive output terminal 713 and a third negative output terminal 715.

Like the two-way differential power divider 100 of FIG. 1 and the three-way differential power divider 600 of FIG. 6, each of the output terminals of the three-way differential power divider 700 is associated with an input capacitor, i.e., input capacitors 716, 718, 720, 722, 723, and 725, and an isolation network is provided to isolate the output terminals from one another. In the example of the three-way differential power divider 700 of FIG. 7, as noted above, a delta-connected isolation network is provided between the respective positive and negative output terminals comprising a number of isolation inductors and isolation resistors, i.e., isolation inductors 726, 728, 732, 738, 742, and 746 and isolation resistors 724, 730, 734, 736, 740, and 744. Additionally, each pair of isolation inductors have an associated mutual inductance, e.g., mutual inductances 748, 750, and 752. Although the specific, actual values for the resistors, capacitors, and inductors of the three-way differential power divider 700 will vary, and thus will need to be selected in accordance with specific implementations and tolerances, in some embodiments, these components are selected in accordance with the following equations 9-12.

$$Lin = Z 0 / √ 2 / ω \qquad [ 9 ]$$

$$Cin = √ 2 / ( Z 0 * ω ) \qquad [ 10 ]$$

$$Liso = Z 0 / √ 2 / ω * ( 1 - km ) \qquad [ 11 ]$$

$$Riso = Z 0 \qquad [ 12 ]$$

Accordingly, as shown in FIGS. 6 and 7 and described above, in some embodiments, a three-way differential Wilkinson power divider includes first, second, and third positive output terminals and first, second, and third negative output terminals corresponding to the positive output terminals and a first delta- or star-connected isolation network connected between the first positive output terminal, the second positive output terminal, and the third positive output terminal, wherein the first isolation network comprises at least a first isolation inductor. Similarly, in some embodiments, a three-way differential Wilkinson power divider includes a second delta- or star-connected isolation network connected between the first negative output terminal, the second negative output terminal, and the third negative output terminal, wherein the second isolation network comprises at least a second isolation inductor.

Additionally, in some embodiments, two or more of the two-way differential power divider 100 of FIG. 1, the three-way differential power divider 600 of FIG. 6, and the three-way differential power divider 700 of FIG. 7 are cascaded to provide non-binary splitting ratios. For example, in some embodiments, a three-way differential power divider is cascaded with three two-way differential power dividers to provide a six-way differential power divider. Generally, two-way and three-way differential power dividers can be cascaded to provide any required number of outputs, and those of ordinary skill in the art will understand that the differential power dividers taught herein, such as the three-way differential power divider 600 of FIG. 6 and the three-way differential power divider 700 of FIG. 7, can be extended along similar lines of the expansion from the two-way differential power divider 100 of FIG. 1 to the three-way differential power dividers 600 and 700 of FIGS. 6 and 7 to four-way differential power dividers, five-way differential power dividers, and so on. Accordingly, in some embodiments, by expanding the design of the three-way differential power dividers 600 and 700 of FIGS. 6 and 7 and/or by cascading multiple differential power dividers, an N-way differential power divider can be produced having any desired number of outputs in accordance with the teachings herein.

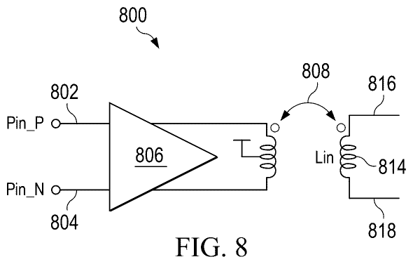

FIG. 8 is a circuit diagram of a transformer 800 usable with a differential Wilkinson power divider, such as one or more of the two-way differential power divider 100 of FIG. 1, the three-way differential power divider 600 of FIG. 6, and the three-way differential power divider 700 of FIG. 7, in accordance with some embodiments. As shown, the transformer 800 includes a first positive input port 802 and a first negative input port 804, an amplifier 806, and a transformer 808, which, in some embodiments, includes an input shunt inductor 814 of the differential power divider as part of the transformer 808. The positive output port 816 and the negative output port 818 are then connected to the input ports of the differential power divider. In some embodiments, the outputs of the transformer 800 are attached to the input ports of a differential power divider to provide impedance matching, balancing or unbalancing, isolation, and/or a voltage step-up or step-down.

For example, transformers can be used to help match different impedance levels between a source and a differential power divider, which helps to maximize power transfer and minimize reflections. Transformers can also convert a balanced signal to an unbalanced signal or vice versa, which can be useful for interfacing between balanced and unbalanced circuits. Transformers also provide electrical isolation between a source and its output, which can help to protect the differential power divider from potential damage due to ground loops or other electrical faults, and in some cases a transformer can be used to step up or step down the voltage levels to suit the requirements of the differential power divider. Accordingly, in some embodiments, the transformer 800 enables a differential power divider like the two-way differential power divider 100 of FIG. 1, the three-way differential power divider 600 of FIG. 6, and/or the three-way differential power divider 700 of FIG. 7 to operate efficiently on a wider range of frequencies than would otherwise be possible without the transformer 800.

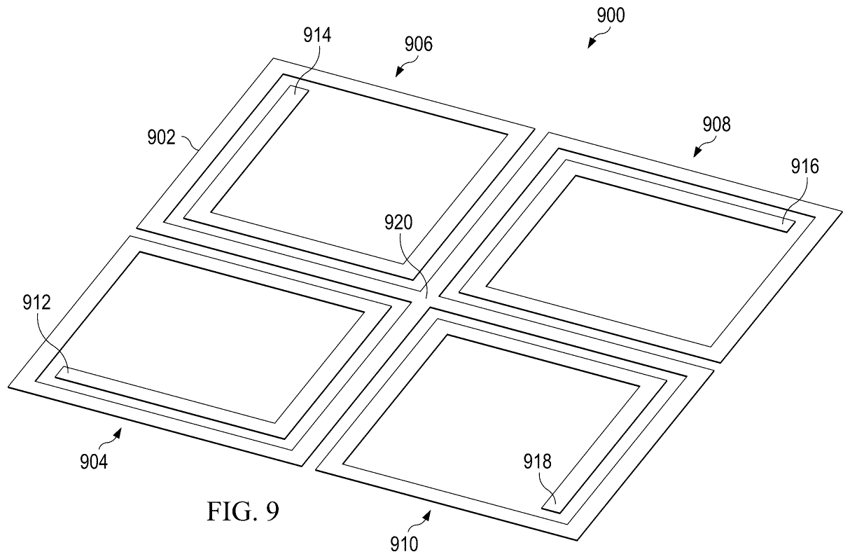

FIG. 9 is a perspective view of a first layer 900 of an isolation network of a three- or four-way differential power divider in accordance with some embodiments, which can be used to implement a portion of the isolation network of, e.g., the three-way differential power divider 600 of FIG. 6 using a star-connected isolation network. As shown in FIG. 9, the first layer 900 of the isolation network includes a positive trace 902 similar to the positive trace 202 of FIG. 2. Like the positive trace 202 of FIG. 2, the positive trace 902 of the first layer 900 of the isolation network shown in FIG. 9 includes a first positive portion 904, a second positive portion 906, a third positive portion 908, and a fourth positive portion 910 connected to a first positive output terminal 912, a second positive output terminal 914, a third positive output terminal 916, and a fourth positive output terminal 918, respectively.

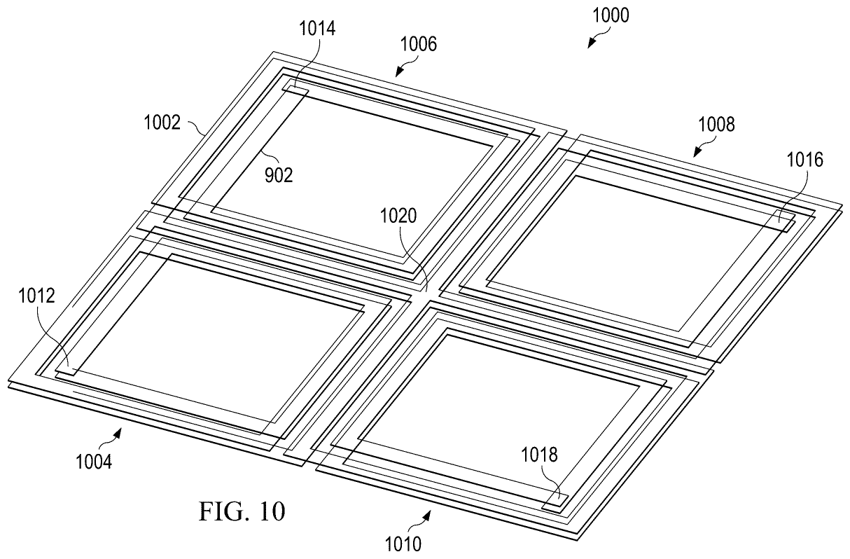

FIG. 10 is a perspective view showing a second layer 1000 of an isolation network of a three- or four-way differential power divider in accordance with some embodiments, which can be used to implement a portion of the isolation network of, e.g., the three-way differential power divider 600 of FIG. 6 using a star-connected isolation network. As shown in FIG. 10, the second layer 1000 of the isolation network includes a negative trace 1002 similar to the positive trace 202 of FIG. 2. Like the negative trace 302 of FIG. 3, the negative trace 1002 of the second layer 1000 of the isolation network shown in FIG. 10 includes a first negative portion 1004, a second negative portion 1006, a third negative portion 1008, and a fourth negative portion 1010 connected to a first negative output terminal 1012, a second negative output terminal 1014, a third negative output terminal 1016, and a fourth negative output terminal 1018, respectively. Notably, the inputs to the positive trace 902 and the negative trace 1002 are at the center of each respective trace where the four respective portions intersect, e.g., at positions 920 and 1020, respectively. As will be appreciated from FIGS. 9 and 10, and similar to the positive trace 202 and the negative trace 302 of FIGS. 3 and 4, the positive trace 902 has rotational symmetry with the negative trace 1002, as rotating the positive trace 902 by 180 degrees around an axis along the center of its width or its length produces the same shape as the negative trace 1002.

As shown in FIG. 10, the first negative portion 1004, the second negative portion 1006, the third negative portion 1008, and the fourth negative portion 1010 each include a spiral configuration having the same chirality, i.e., a counter-clockwise chirality when viewed from the perspective of FIG. 10. Similarly, the first positive portion 904, the second positive portion 906, the third positive portion 908, and the fourth positive portion 910 of FIG. 9 each include a spiral configuration having the same chirality, i.e., a clockwise chirality when viewed from the perspective of FIG. 9, which is opposite to the chirality of the negative portions of the negative trace 1002. However, it will be appreciated that, in some embodiments, the positive trace 902 of the three-way differential power divider can be used as a negative trace and that the negative trace 1002 can be used as a positive trace. Accordingly, in some embodiments, the chirality of the spiral configurations of the negative trace is clockwise while the chirality of the spiral configurations of the positive trace is counter-clockwise.

As will be appreciated from FIGS. 9 and 10, and similar to the spiral configurations of FIGS. 3 and 4, the shapes of the spiral configuration of each adjacent negative portion of the positive trace 902 or the negative trace 1002 are identical when rotated by 90 degrees around an axis normal to the plane of the traces. For example, rotating the spiral configuration of the first positive portion 904 of the positive trace 902 of FIG. 9 by 90 degrees around an axis normal to the plane of the positive trace 902 produces a shape identical to the shape of the spiral configuration of the second positive portion 906 of the positive trace 902. Similarly, rotating the spiral configuration of the first negative portion 1004 of the negative trace 1002 of FIG. 10 by 90 degrees around an axis normal to the plane of the negative trace 1002 produces a shape identical to the shape of the spiral configuration of the second negative portion 1006 of the negative trace 1002.

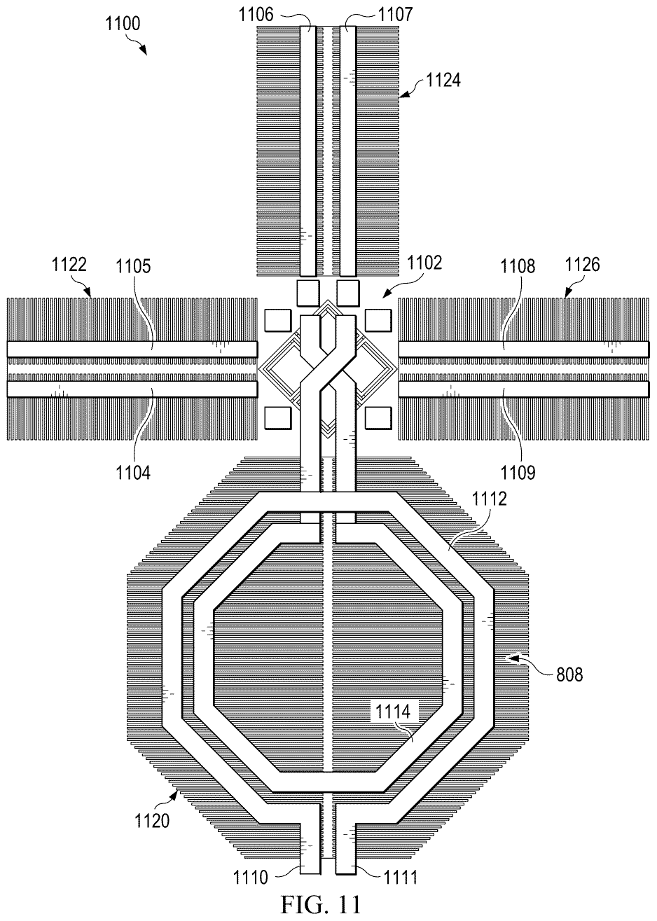

Similar to the spiral configurations of FIGS. 3 and 4, using these variously symmetric spiral configurations for the positive and negative portions of the positive trace and negative traces 902, 1002 where the positive trace 902 and the negative trace 1002 include spiral configurations with opposite chirality provides for a field cancellation effect with respect to other components, such as an input coil 1112 and an output coil 1114, as described below with reference to FIG. 11. Additionally, as shown in FIGS. 9 and 10, the geometries of the positive trace 902 and the negative trace 1002 effectively produce the isolation inductors 626, 632, 638 and the isolation inductors 628, 642, and 646, respectively, of the three-way differential power divider 600 of FIG. 6 using a star-connected isolation network.

FIG. 11 is a top view of a three-way differential power divider 1100 including a transformer in accordance with some embodiments. As shown in FIG. 11, the three-way differential power divider 1100 includes an isolation network 1102 having first and second layers like the first layer 900 of FIG. 9 and the second layer 1000 of FIG. 10, where only three of the four positive and negative output terminals are utilized. First, second, and third positive terminals 1104, 1106, and 1108 and first, second, and third negative terminals 1105, 1107, and 1109 are provided as outputs from the three-way differential power divider 1100. A positive input and a negative input are provided at a positive input terminal 1110 and a negative input terminal 1111, respectively, which are provided to the inputs of the transformer 808 of FIG. 8. The transformer 808 includes an input coil 1112 and an output coil 1114, which also acts as an input shunt inductor for the three-way differential power divider 1100. Additionally, as shown in FIG. 11, the transformer 808 and the traces corresponding to the positive terminals 1104, 1106, and 1108 and the negative terminals 1105, 1107, and 1109 are deposited over electromagnetic shields 1120, 1122, 1124, and 1126.

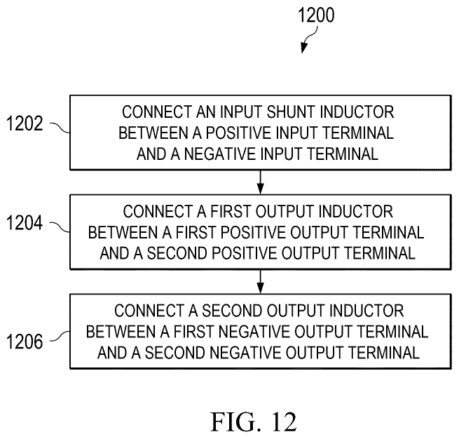

FIG. 12 is a flow diagram of a method 1200 of assembling a differential Wilkinson power divider, such as one of the differential power dividers of FIGS. 1, 5, 6, 7, and 11, in accordance with some embodiments. As shown in FIG. 12, at block 1202, an input shunt inductor, such as one of the input shunt inductors 114, 614, 714, and 1114 of FIGS. 1, 5, 6, 7, and 11, is connected between a positive input terminal and a negative input terminal, such as one of the positive and negative input terminals of FIGS. 1, 5, 6, 7, and 11. At block 1204, a first isolation inductor, such as one of the isolation inductors of FIGS. 1, 2, 3, 5, 6, 7, and 11, is connected between a first positive output terminal and a second positive output terminal. At block 1206, a second isolation inductor is connected between a first negative output terminal and a second negative output terminal. In some embodiments, the first isolation inductor and the second isolation inductor are provided with a first mutual inductance, the input shunt inductor and the first isolation inductor are provided with a second mutual inductance, as shown for example in FIGS. 1, 6, and 7, and a coefficient of coupling of the first mutual inductance has a higher magnitude than a coefficient of coupling of the second mutual inductance. In some embodiments, the input shunt inductor and the second isolation inductor have a third mutual inductance, and a coefficient of coupling of the first mutual inductance has a higher magnitude than a coefficient of coupling of the third mutual inductance. In some embodiments, the method 1200 comprises connecting a first delta- or star-connected isolation network, as shown in FIGS. 6, 7, 9, 10, and 11, between the first positive output terminal, the second positive output terminal, and a third positive output terminal, wherein the first isolation network comprises the first isolation inductor. In some embodiments, the method 1200 comprises connecting a second delta- or star-connected isolation network, as shown in FIGS. 6, 7, 9, 10, and 11, between the first negative output terminal, the second negative output terminal, and a third negative output terminal, wherein the second isolation network comprises the second isolation inductor. In some embodiments, the method 1200 comprises connecting a third isolation inductor, as shown in FIGS. 6, 7, 9, 10, and 11, between the first positive output terminal and the third positive output terminal.

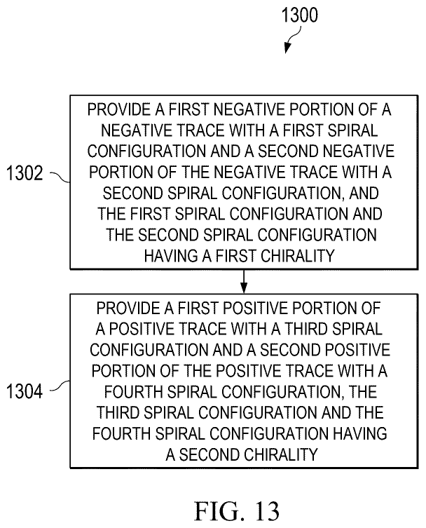

FIG. 13 is a flow diagram of a method 1300 of arranging traces in a differential Wilkinson power divider, such as one of the differential power dividers of FIGS. 1, 5, 6, 7, and 11, in accordance with some embodiments. At block 1302, a first negative portion of a negative trace is provided with a first spiral configuration and a second negative portion of the negative trace with a second spiral configuration, and the first spiral configuration and the second spiral configuration having a first chirality, as shown for example in FIGS. 3 and 10. At block 1304, a first positive portion of a positive trace is provided with a third spiral configuration and a second positive portion of the positive trace with a fourth spiral configuration, the third spiral configuration and the fourth spiral configuration having a second chirality, as shown for example in FIGS. 2 and 9. In some embodiments, the second chirality is configured differently from the first chirality, such as an opposite chirality. For example, in some embodiments, the first chirality is clockwise and the second chirality is counter-clockwise. In other embodiments, the first chirality is counter-clockwise and the second chirality is clockwise.

In some embodiments, certain aspects of the techniques described above, such as the methods 1200, 1300, may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1-15. (canceled)

16. A differential Wilkinson power divider, comprising:
an input shunt inductor between a positive input terminal and a negative input terminal;
a first isolation inductor between a first positive output terminal and a second positive output terminal; and
a second isolation inductor between a first negative output terminal and a second negative output terminal,
wherein the first isolation inductor and the second isolation inductor have a first mutual inductance, the input shunt inductor and the first isolation inductor have a second mutual inductance, and a coefficient of coupling of the first mutual inductance has a higher magnitude than a coefficient of coupling of the second mutual inductance.

17. The differential Wilkinson power divider of claim 16, wherein the input shunt inductor and the second isolation inductor have a third mutual inductance, and a coefficient of coupling of the first mutual inductance has a higher magnitude than a coefficient of coupling of the third mutual inductance.

18. The differential Wilkinson power divider of claim 16, further comprising:
a third positive output terminal and a third negative output terminal corresponding to the third positive output terminal; and
a first delta- or star-connected isolation network connected between the first positive output terminal, the second positive output terminal, and the third positive output terminal, wherein the first isolation network comprises the first isolation inductor.

19. The differential Wilkinson power divider of claim 18, further comprising:
a second delta- or star-connected isolation network connected between the first negative output terminal, the second negative output terminal, and the third negative output terminal, wherein the second isolation network comprises the second isolation inductor.

20. A differential Wilkinson power divider, comprising:
a negative trace comprising a first negative portion and a second negative portion; and
a positive trace comprising a first positive portion and a second positive portion,
wherein the first negative portion of the negative trace includes a first spiral configuration, the second negative portion of the negative trace includes a second spiral configuration, and the first spiral configuration and the second spiral configuration have a first orientation, and
wherein the first positive portion of the positive trace includes a third spiral configuration, the second positive portion of the positive trace includes a fourth spiral configuration, the third spiral configuration and the fourth spiral configuration have a second orientation, and the second orientation is different from the first orientation.

21. The differential Wilkinson power divider of claim 20, wherein the first orientation is opposite to the second orientation.

22. The differential Wilkinson power divider of claim 20, wherein a shape of the first spiral configuration is identical to a shape of the second spiral configuration when the shape of the second spiral configuration is rotated 180 degrees.

23. The differential Wilkinson power divider of claim 20, wherein a shape of the third spiral configuration is identical to a shape of the fourth spiral configuration when the shape of the fourth spiral configuration is rotated 180 degrees.

24. The differential Wilkinson power divider of claim 20, wherein:
the negative trace further comprises a third negative portion and a fourth negative portion;
the positive trace further comprises a third positive portion and a fourth positive portion;
the third negative portion of the negative trace includes a fifth spiral configuration, the fourth negative portion of the negative trace includes a sixth spiral configuration, and the fifth spiral configuration and the sixth spiral configuration have the first orientation; and
the third positive portion of the positive trace includes a seventh spiral configuration, the fourth positive portion of the positive trace includes an eighth spiral configuration, and the seventh spiral configuration and the eighth spiral configuration have the second orientation.

25. The differential Wilkinson power divider of claim 24, wherein a shape of the first spiral configuration is identical to a shape of the second spiral configuration when the shape of the second spiral configuration is rotated 90 degrees.

26. The differential Wilkinson power divider of claim 25, wherein the shape of the second spiral configuration is identical to a shape of the fifth spiral configuration when the shape of the fifth spiral configuration is rotated 90 degrees.

27. The differential Wilkinson power divider of claim 24, wherein a shape of the third spiral configuration is identical to a shape of the fourth spiral configuration when the shape of the fourth spiral configuration is rotated 90 degrees.

28. The differential Wilkinson power divider of claim 27, wherein the shape of the fourth spiral configuration is identical to a shape of the seventh spiral configuration when the shape of the seventh spiral configuration is rotated 90 degrees.

29. The differential Wilkinson power divider of claim 20, further comprising an input shunt inductor between a positive input terminal and a negative input terminal.

30. The differential Wilkinson power divider of claim 29, wherein:
the positive trace forms a first isolation inductor between a first positive output terminal and a second positive output terminal;
the negative trace forms a second isolation inductor between a first negative output terminal and a second negative output terminal; and
the first isolation inductor and the second isolation inductor have a first mutual inductance, the input shunt inductor and the first isolation inductor have a second mutual inductance, and a coefficient of coupling of the first mutual inductance has a higher magnitude than a coefficient of coupling of the second mutual inductance.

31. A differential Wilkinson power divider, comprising:
a negative trace comprising a first negative portion and a second negative portion and forming a first isolation inductor between a first positive output terminal and a second positive output terminal; and
a positive trace comprising a first positive portion and a second positive portion and forming a second isolation inductor between a first negative output terminal and a second negative output terminal,
wherein the first negative portion of the negative trace includes a first spiral configuration, the second negative portion of the negative trace includes a second spiral configuration, and the first spiral configuration and the second spiral configuration have a first orientation.

32. The differential Wilkinson power divider of claim 31, further comprising an input shunt inductor between a positive input terminal and a negative input terminal.

33. The differential Wilkinson power divider of claim 32, wherein the first isolation inductor and the second isolation inductor have a first mutual inductance, the input shunt inductor and the first isolation inductor have a second mutual inductance, and a coefficient of coupling of the first mutual inductance has a higher magnitude than a coefficient of coupling of the second mutual inductance.

34. The differential Wilkinson power divider of claim 31, wherein the first positive portion of the positive trace includes a third spiral configuration, the second positive portion of the positive trace includes a fourth spiral configuration, the third spiral configuration and the fourth spiral configuration have a second orientation, and the second orientation is different from the first orientation.

35. The differential Wilkinson power divider of claim 34, wherein the first orientation is opposite to the second orientation.
